(19) United States
(12) Patent Application Publication
(10) Pub. No.: US 2023/0267243 A1
(43) Pub. Date: Aug. 24, 2023

(54) GENERATING CONSOLIDATED DESIGNS OF A PRODUCTION MODEL TO REPLACE MULTIPLE PARTS OF AN ASSEMBLY

(71) Applicant: Palo Alto Research Center Incorporated, Palo Alto, CA (US)

(72) Inventors: Amirmassoud Mirzendehdel, Millbrae, CA (US); Morad Behandish, Palo Alto, CA (US)

(21) Appl. No.: 18/172,138

(22) Filed: Feb. 21, 2023

Related U.S. Application Data
(60) Provisional application No. 63/312,757, filed on Feb. 22, 2022.

(51) Int. Cl. G06F 30/17; G06F 30/20

(52) U.S. Cl. CPC G06F 30/17; G06F 30/20; G06F 2111/04

(57) ABSTRACT

Techniques, devices, and systems for automatically generating consolidated designs of a production model to replace multiple parts of an assembly are disclosed herein. For example, a set of digital models may be originally designed to be separately manufactured and assembled post production. The present disclosure analyzes the set of digital models and computes candidates of consolidated designs that consolidates a subset number of the digital models into a single part to be manufactured. The computation may be based on certain complexity level (e.g., based on manufacturing capability and/or user preference/input). The consolidated designs simplify the manufacturing process by reducing individual parts to be manufactured and the subsequent assembly, as well as improving reliability, improving automation, and reducing manufacturing costs.

### CROSS-REFERENCE TO RELATED APPLICATION

This application claims the priority and benefits of U.S. Provisional Application Ser. No. 63/312,757, entitled “Generating Consolidated Designs of a Production Model to Replace Multiple Parts of an Assembly,” filed on Feb. 22, 2022, the disclosure of which are incorporated herein by reference in its entirety.

### FIELD

Implementations of the present disclosure relate to modifying digital components for production or manufacturing.

### BACKGROUND

An assembly of components or parts may be redesigned or modified in order to reduce weight and/or complexity of the assembly (known as light-weighting or lightweighting). Light-weighting of components can have significant impact on cost and environmental footprint of industries such as aerospace and automotive, where legacy parts can be redesigned for a specific manufacturing process such as additive manufacturing (AM) or Sub-tractive manufacturing (SM). However, to provide a cost-effective option to engineers, a holistic view of the entire assembly of parts needs be considered while considering manufacturability, production cost, operation cost, energy consumption, etc.

### SUMMARY

The present disclosure provides systems, methods, and techniques for automatically generating consolidated designs of a production model to replace multiple parts of an assembly. For example, the consolidated designs may simplify the overall production-assembly requirements and achieve light-weighting. Instead of separately manufacturing different parts represented by corresponding digital models, a single part corresponding to the assembly of the different parts may be generated using topology optimization and produced by additive manufacturing, subtractive manufacturing, or both.

In a general aspect, an apparatus for consolidating multiple digital models includes a memory and a processing device operably coupled to the memory. The processing device and the memory are configured to identify the multiple digital models to be assembled post production (e.g., the digital models and the respective physical parts are to be assembled or connected given certain relationships). The processing device and the memory are further configured to extract a system network (e.g., interactive relationships of the multiple digital models, such as relative movements or the lack thereof) based on types and interactions of the identified digital models. The processing device then generates, based on the system network, one or more candidate structures representing an assembly of the identified digital models. The processing device further generates, based on the one or more candidate structures, a consolidated model to be manufactured and functionally replace the identified digital models.

In some embodiments, the processing device and the memory are further to receive an initial set of digital models comprising computer aided design (CAD) models. Each of the initial set of digital models is originally designed to be individually manufactured and assembled with others in the initial set of digital models. In some cases, the multiple digital models are identified from the initial set of digital models based on a set of production context corresponding to the types and interactions of the identified digital models. For example, the set of production context may include a functional aspect of the identified digital models, including, for example, at least one of a key, a spacer, a housing, or a load bearing function performed by each of the multiple digital models. The set of production contexts may also include a connection aspect of the identified digital models, including at least a relative movement or fixation between two or more of the digital models. The connection aspect represents an assembly relationship of the two or more of the digital models.

In some embodiments, the processing device and the memory are to extract the system network by: abstracting each of the identified digital models into a volume-less symbol; and defining a relationship between every two of the identified digital models in a design structure matrix. In some cases, the relationship includes at least one of: a relative motion or a lack thereof, stiffness, an electrical connection, a heat energy transfer, a boundary condition, or a loading condition. In some cases, the processing device and the memory are to generate the one or more candidate structures representing the assembly of the identified digital models by computing the one or more candidate structures based on a combination or a permutation of a subset of the volume-less symbols of the system network based on the defined relationship for different levels of complexity.

In some cases, the processing device and the memory are to generate the consolidated model to be manufactured by: performing topology optimization based on the one or more candidate structures and constraints of at least one of loading conditions, boundary conditions, manufacturing parameters, costs, or performance; and generating a set of parameters of the consolidated model for manufacturing based on results of the topology optimization. For example, the set of parameters of the consolidated model is used in additive manufacturing, subtractive manufacturing, or a combination of both.

In another general aspect, a method for consolidating a number of digital models to be manufactured is disclosed. The method includes identifying the digital models to be assembled post production; extracting a system network based on types and interactions of the identified digital models; generating, by a processing device based on the system network, one or more candidate structures representing an assembly of the identified digital models; and generating, based on the one or more candidate structures, a consolidated model to be manufactured and functionally replace the identified digital models.

In another general aspect, a non-transitory computer-readable storage medium having instructions stored thereon that, when executed by a processing device for consolidating multiple digital models to be manufactured, cause the processing device to: identify the digital models to be assembled post production; extract a system network based on types and interactions of the identified digital models; generate one or more candidate structures representing an assembly of the identified digital models; and generate, based on the one or more candidate structures, a consolidated model to be manufactured and functionally replace the identified digital models.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a block diagram of an automatic consolidated designs generation, in accordance with certain aspects of the present disclosure.

FIGS. 2A-2C illustrate an example process flow of automatic consolidated design generation for a quadcopter assembly, in accordance with certain aspects of the present disclosure.

FIG. 3A illustrates an example additive manufacturing system, in accordance with certain aspects of the present disclosure.

FIG. 3B illustrates an example subtractive manufacturing system, in accordance with certain aspects of the present disclosure.

FIG. 4 illustrates examples of automatically generating optimized consolidated designs at different levels of complexity, in accordance with certain aspects of the present disclosure.

FIG. 5 illustrates example consolidated designs, topologically optimized, for additive manufacturing or subtractive manufacturing, in accordance with certain aspects of the present disclosure.

FIG. 6 illustrates a flow diagram of methods of operations, in accordance with certain aspects of the present disclosure.

FIG. 7 illustrates a flow diagram of methods of operations, in accordance with certain aspects of the present disclosure.

FIG. 8 illustrates an example computational device for performing operations of topology optimization, in accordance with certain aspects of the present disclosure.

Like numerals indicate like elements.

### DETAILED DESCRIPTION

The present disclosure provides various techniques for automatically generating consolidated designs of a production model to replace multiple parts of an assembly. For example, a set of digital models may be originally designed to be separately manufactured and assembled post production. The present disclosure analyzes the set of digital models and computes candidates of consolidated designs that consolidates a subset number of the digital models into a single part to be manufactured. The computation may be based on certain complexity level (e.g., based on manufacturing capability and/or user preference/input). The consolidated designs simplify the manufacturing process by reducing individual parts to be manufactured and the subsequent assembly, as well as improving reliability, improving automation, and reducing manufacturing costs.

According to aspects of the present disclosure, a method for automatically generating consolidated designs for a number of digital models may include identifying the number of digital models to be assembled post production (e.g., identifying a subset of an overall assembly to be consolidated). The method further includes extracting a system network (also referred to as upscaling) based on types and interactions of the identified number of digital models. The method includes generating one or more candidate structures representing an assembly of the identified number of digital models. The candidate structures may represent part or all of the identified number of digital models assembled. The method further includes generating, based on the one or more candidate structures, a consolidated model to be manufactured and to functionally replace the identified number of digital models.

For example, the disclosed method and system may automate part consolidation to meet the manufacturing requirements (e.g., in view of an assembly of multiple parts) while reducing complexity of part interactions. As input, for a given 1) legacy assembly (e.g., computer aided designed (CAD) components to be assembled post production), 2) a set of functionalities (of the components), and 3) different manufacturing processes (e.g., available manufacturing environment and methods), the disclosed method computes whether redesigning (e.g., generating a replacement part) may improve performance and cost, and if so, automatically generates a single part to be manufactured in the place of the legacy assembly. The single part may functionally replace those of the legacy assembly while achieving a reduced cost of production, as well as light-weighting.

According to aspects of this disclosure, an assembly of parts may be quantified by first generating a system network (e.g., a representation of the assembly of parts) through upscaling (e.g., a process of abstracting and representing components using volume-less symbols or representations). A design structure matrix of the system network may be constructed to identify or represent the relationships among the abstract symbols or representations. The complexity of a system network can be evaluated and/or expressed as sum of the singular values in the design structure matrix. Based on the different levels of complexity as expressed by the sum of the singular values, the disclosed method may automatically generate sub-assembly candidates for consolidation. Subsequently, the method may generate optimized designs using automated design techniques such as topology optimization. The technical details, and various implementations are described using examples herein. A simplified example algorithmic description of the implementation is also provided.

The consolidated part may be generated in view of a combination of manufacturing techniques. At a high level, additive manufacturing (AM) technologies are capable of fabricating geometrically complex parts by adding material layer-by-layer (thus capable of producing internal structures inaccessible by machining tools). For example, metal AM techniques such as jetting, fused deposition, or laser sintering, may leverage geometric complexity to design high-performance and light-weight parts/designs for in aerospace, automotive, medical applications, etc.

Subtractive manufacturing (SM) techniques such as multi-axis machining have been widely used for manufacturing high-quality reproducible parts across multiple industries including aerospace and automotive. In SM, the production often begins with a raw stock of material and gradually carve out material until the desired shape emerges. In some cases, SM and AM may be combined, such as producing a complicated geometry using AM first, and then machining the geometry with SM to achieve particular surface quality or specific dimensions (e.g., a bored hole requiring tolerance levels exceeding AM cost/capabilities).

Although the present disclosure illustrates consolidated design examples regarding AM and/or SM, other manufacturing processes may also be used when consolidated designs are generated. For example, other manufacturing processes may include injection molding, casting, weaving, among others. The manufacturing processes may be defined as conditions with various parameters in a topology optimization process. For example, an initial shape may be topologically optimized for one or more specific manufacturing processes.

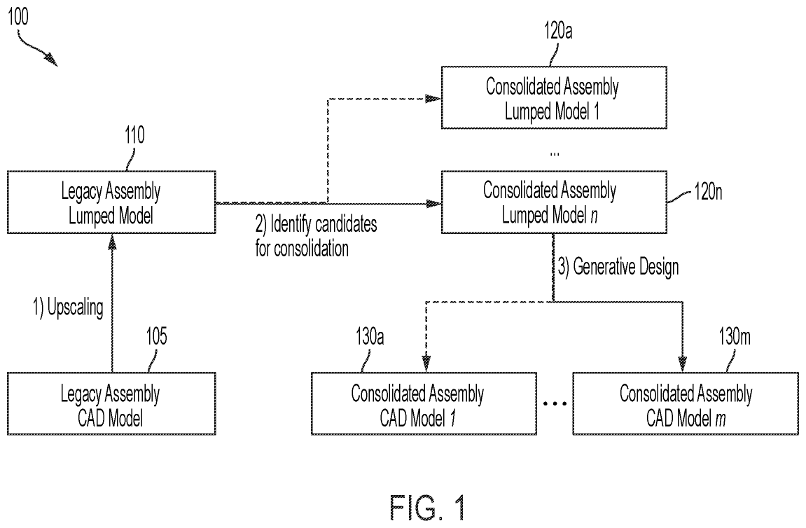

FIG. 1 illustrates a block diagram 100 of an example method of automatic consolidated designs generation, in accordance with certain aspects of the present disclosure. The example method for automated part consolidation may include the following. First, the method includes upscaling, which creates a lumped model of the target assembly or system and generates or extracts a system network based on the part or component types and their interactions. Second, the method includes identifying replacement candidates, which includes generating consolidation candidates to optimize the trade-off between complexity, cost, and performance. Third, the method includes generating a generative design, which includes defining new design domains, transferring loading conditions from the legacy problem, and generating consolidated designs.

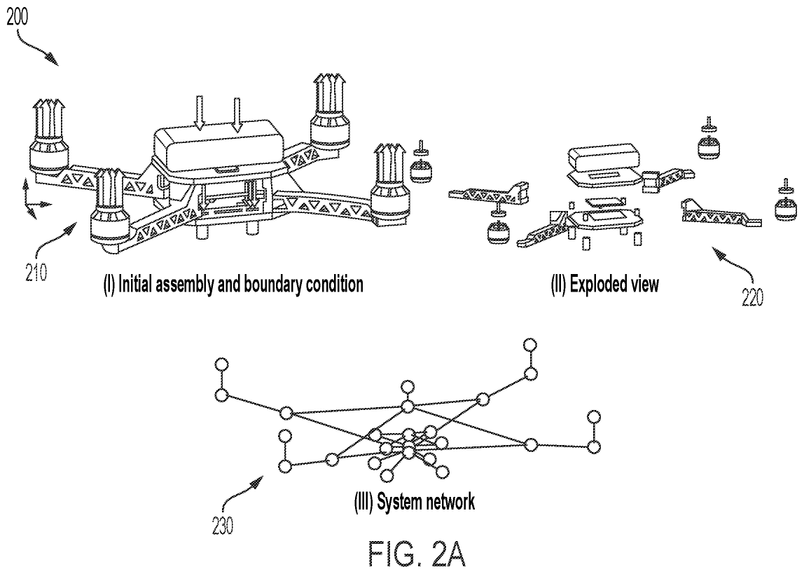

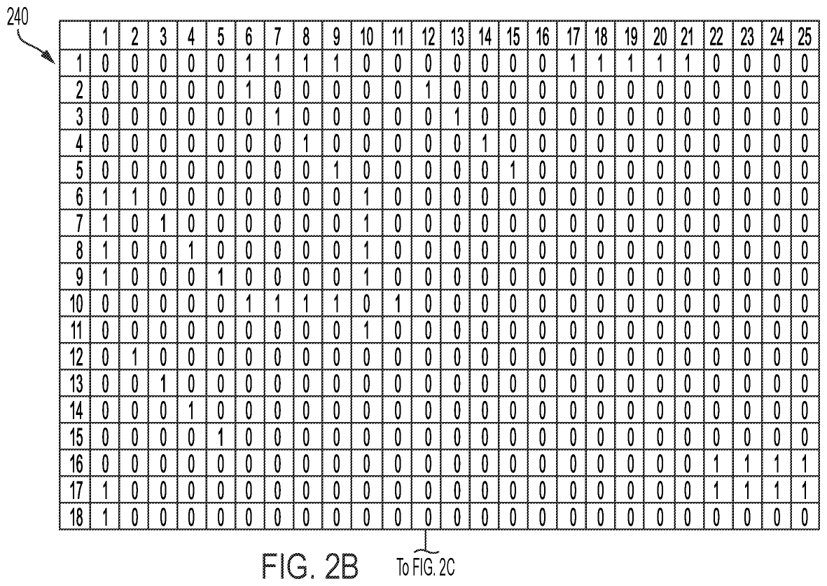

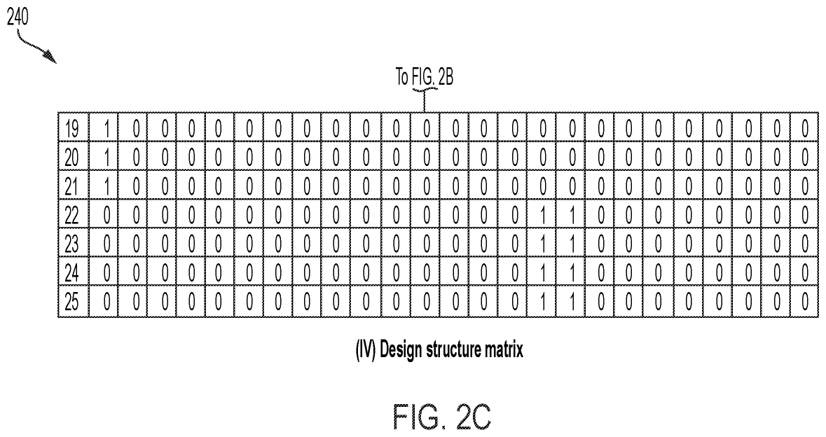

As shown, the block diagram 100 may start at receiving a legacy assembly CAD model 105, which represents multiple original computer aided design (CAD) models that are meant to be individually produced, by different methods (e.g., milling, turning, forging, etc.) in different materials (e.g., metal, composites, plastics, etc.). An example of the CAD model assembly 105 is shown in parts I and II (assembled view 210 and exploded view 220) of FIG. 2A.

According to aspects of the present disclosure, the CAD models 105 may be processed or upscaled (e.g., referring to the processing as “upscaling”) to be a legacy assembly lumped model 110, which is a system network model. For example, the system network model includes a network of multiple abstract nodes that represent each of the original CAD models 105. An example of the system network model 230 is shown in part III of FIG. 2A. This upscaling process may consider the various properties (relative movement, electrical connections, energy transfer, signaling, etc.) of the relationships between the original CAD models. The upscaling process may also be based on the properties and type (e.g., key, spacer, housing, etc.) of each of the original CAD models 105.

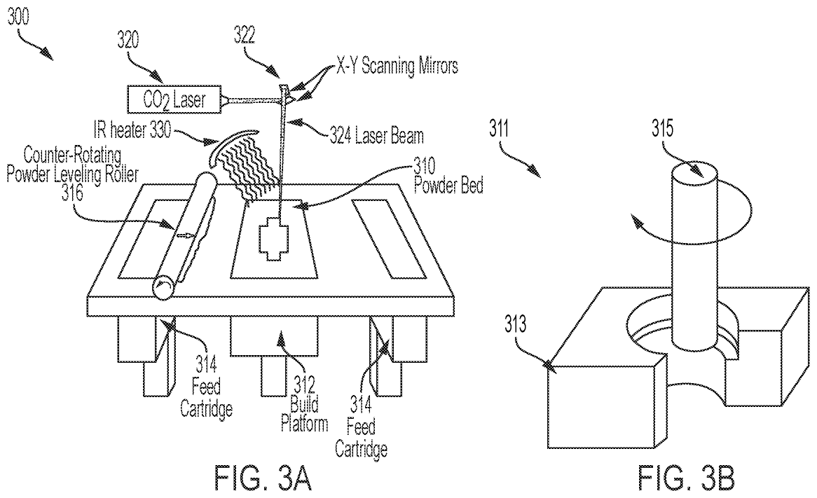

As shown in FIG. 1, based on the assembly lumped model 110, multiple candidates 120a, . . . , 120n (e.g., labeled from 1 through n) of consolidated assembly lumped models may be generated or identified to represent the assembly lumped model 110. The assembly lumped models 120a-120n are referred to as candidates for consolidation. The multiple candidates 120a-120n are then used in generative design processes to generate a number of consolidated assembly CAD models 130a-130m (e.g., labeled from 1 through m). In other words, based on the multiple consolidated assembly lumped models 1 through n, multiple consolidated designs (referred to as consolidated assembly CAD models 130a-130m), may then be generated, such as by topology optimization based on manufacturability, boundary conditions, and/or loading conditions (and other functional requirements, such as electrical signals or energy transfer). The automatic generation of the consolidated assembly CAD models is further discussed and illustrated in relation to FIG. 3 below.

In the block diagram 100 of FIG. 1, the candidates 120a-120n for consolidation may be identified by consolidating different subsets of the system network, for example, unifying a different subset of the abstract nodes for each candidate for consolidation. The candidates 120a-120n are automatically generated based on predefined combination and/or permutation rules to represent different levels of system complexity. For example, the complexity of a given assembly may be computed using a structural complexity metric, which may be expressed as:

C=C₁+C₂C₃

Here, C₁ denotes component complexity, C₂ denotes the complexity of interfaces, and C₃ denotes the topological complexity of system. To compute C₃ for an n-component assembly, the system connectivity network may first be realized. Then, the system connectivity network's adjacency matrix A∈M_{n×n}, called the design structure matrix (DSM), may be constructed as:

$${A}_{i j} = \{ \begin{matrix}1 , \{ ∀ ( i , j ) , i \neq j and ( i , j ) ∈ Λ \} \\ 0 , otherwise\end{matrix}$$

∧ is the set of connected components shown as nodes in the graph of FIGS. 2A-2C (e.g., Parts III and IV). The topological complexity C₃ is defined as the graph energy of the network that is expressed as sum of its singular values σ and computed using the singular value decomposition method:

$${C}_{3} = {\sum }_{i = 1}^{n} {σ}_{i}$$

An example graph energy of 26.36 of a design structure matrix (Part IV) is illustrated in FIGS. 2B-2C and discussed below.

FIG. 2 illustrates an example process flow 200 of automatic consolidated design generation for a quadcopter assembly, in accordance with certain aspects of the present disclosure. As shown, part I illustrates the initial assembly 210 of a quadcopter, that is, a body of a drone having four rotors (not shown) operable to carry the payload at the middle. Part I also illustrates the boundary conditions (e.g., arrows representing forces applied to corresponding parts) for the digital models of individual components of the quadcopter, such as lifting forces applied to each rotor end and gravitational forces represented in the middle of the body.

To illustrate the relationship between individual components of the assembly 210, in part II of FIG. 2A, each of the digital models is illustrated in an exploded view 220. The exploded view 220 shows the multiple individual parts intended to be separately made and subsequently assembled. As discussed above, to achieve lightweighting, reliability, and leveraging advanced manufacturing techniques, a subset of the multiple separate parts is to be consolidated into a single, replacement part that provides similar or same functions as the assembly 210.

To generate the consolidated replacement part, abstract nodes are used to represent each of the digital models, as illustrated in part III of FIG. 2A. The abstract nodes are connected based on respective relationships. For example, one type of connection may represent an affixation relationship, while another type of connection may represent a relative movement relationship (e.g., part of a motor moving relative to the body frame of the quadcopter). The connected abstract nodes form the system network 230. Because the system network 230 does not

Part IV (a tabulated design structure matrix) of FIGS. 2B-2C illustrates an example design structure matrix 240 indicating relations between every two of the digital models of the individual components. As mentioned above, the design structure matrix 240 shows a graph energy of 26.36. To generate the design structure matrix 240, the digital models represented by the abstract nodes in the system network 230 are labeled and ordered in each dimension of the matrix (e.g., from 1 to 25). The value “1” indicates the corresponding components in the row and in the column are related or connected, while the value “0” indicates that no such relation exists between the two. One or more such matrix corresponding to particular relation types may be used to indicate multiple types of relationships (e.g., mechanical connections, electrical connections, heat transfers, etc.).

The consolidated designs may be generated, using the design structure matrix 240 and the system network 230, in an iterative loop to improve or optimize certain quantifiable aspects, such as cost, production time, material used, and the like. For example, by consolidating multiple parts into one, production time may be reduced due to the lack of need of assembly. Using additive manufacturing to produce the consolidated part may also reduce cost due to material savings or allowance for error tolerances (as part fittings are not required).

FIG. 3A illustrates an example additive manufacturing (AM) system 300, in accordance with certain aspects of the present disclosure. FIG. 3A illustrates a general concept of AM production technique, such as selective laser sintering (SLS), selective laser melting (SLM), laser powder bed fusion (LPBF), and other similar additive manufacturing methods. The consolidated designs may be generated and optimized specific to the additive manufacturing methods used, allowing for complicated internal structures not traditionally reachable using machining tools.

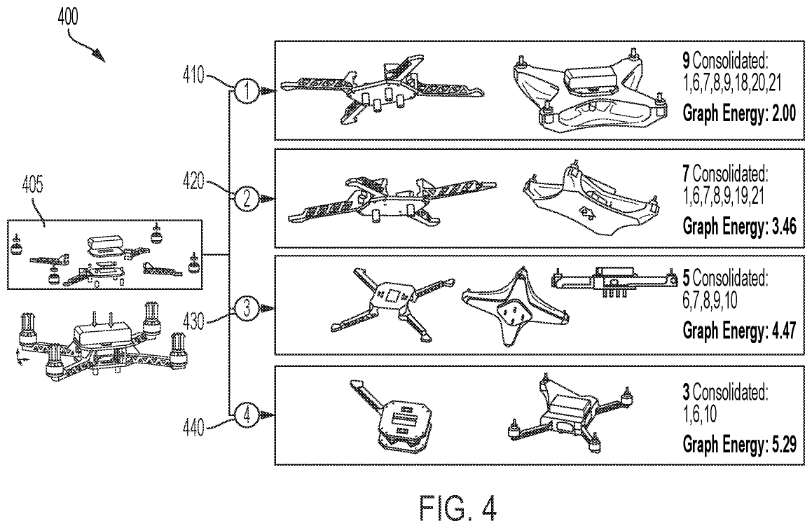

As shown in FIG. 3A, the example additive manufacturing system 300 includes a powder bed 310 on a build platform 312 for forming each layer according to a digital part provided to the system 300. Multiple feed cartridges 314 and the powder leveling roller 316 provide fresh powder for the next layer once the current layer formation has been completed. A laser 320 directed by scanning mirrors 322 uses laser beams 324 to locally turn the powders into a continuous piece of solid (e.g., by melting and solidifying). A radiator 330 provides heat to control the rate of cooling and heat treatment to the fused solid layer. A consolidated part (examples shown in FIG. 4) optimized for performance may be producible by the additive manufacturing system 300.

FIG. 3B illustrates an example subtractive manufacturing (SM) system 311, in accordance with certain aspects of the present disclosure. As shown, subtractive manufacturing may include a cutting or grinding tool 315, removing materials from the work piece 313. The work piece 313 may be oriented and moved at various positions in different rates relative to the tool 315, to form any designed shape. The consolidated designs may be generated and optimized specific to the subtractive manufacturing methods used. The subtractive manufacturing may be used when materials of high strength to weight ratio is used; while the additive manufacturing may be selected when a complex shape is not reasonably feasible by subtractive machining.

In some cases, the work piece 313 may be produced using the AM system 300. For example, a consolidated part may first be shaped using AM techniques into the work piece 313. The SM system 311 may further remove materials on the work piece 313, such as for achieving surface quality, to finalize the production of the consolidated part. A combination of AM and SM manufacturing may be referred to as hybrid manufacturing.

FIG. 4 illustrates examples of automatically generating optimized consolidated designs (e.g., 410-440) at different levels of complexity, in accordance with certain aspects of the present disclosure. As shown, the digital parts 405 of the exploded view 220 of FIG. 2A may be consolidated by using different subsets of the digital parts 405. Four consolidated designs 410, 420, 430, and 440 are illustrated. In the consolidated design 410, nine components of the digital parts 405 are consolidated into one, with a graph energy of 2.00. In the consolidated design 420, seven components of the digital parts 405 are consolidated into one, with a graph energy of 3.46. In the consolidated design 430, five components of the digital parts 405 are consolidated into one, with a graph energy of 4.47. In the consolidated design 440, three components of the digital parts 405 are consolidated into one, with a graph energy of 5.29.

The advances in computational hardware, material sciences, and manufacturing technologies allow for generative algorithms for exploring an expanded design space and introduce low-cost yet high-performance designs that can have multiple functionalities. For example, a processing device may generate part designs based on prescribed conditions and limited initial design input from the users, and iteratively generate designs or design improvements to meet the prescribed conditions. Different automated design generation techniques, such as topology optimization, machine learning, cellular automata, etc., have been developed to varying degrees to consider the physical performance of a part so as to generate non-trivial organic shapes. The organic shapes can increase the geometric and manufacturing complexity of components captured by C₁. In some cases, generating the consolidated designs include solving a topology optimization problem described below:

$$\begin{matrix}{Minimize}_{Ω ⊆ {Ω}_{0}} & ψ ( Ω ) , \\ such that & [ {K}_{Ω} ] [ {u}_{Ω} ] = [ f ] , \\ & {V}_{Ω} \leq {V}_{target} ,\end{matrix}$$

where φ(Ω)ϵR is the value of objective function for a given design Ω⊆Ω₀. [f], [u_{Ω}], and [K_{Ω}] are (discretized) external force vector, displacement vector, and stiffness matrix, respectively, for FEA. V_{Ω}≈vol[Ω] represents the design volume and V_{target}>0 is the volume budget.

The consolidated designs (e.g., 410-440, or any part that is redesigned from an assembly of parts) are generated by performing the following operations: (1) analyzing physics-based performance, such as invoking physics solvers such as finite element analysis to evaluate objective and constraints; (2) computing decision variables, such as computing the optimization decision variables such as gradients, sensitivity fields, etc. based on objective and constraints; (3) applying design and manufacturing constraints, such as to augment/filter decision variables based to/by design and manufacturing considerations; and (4) generating consolidated designs, such as to update design variables based on decision variables and generate an optimized design.

In some aspects, the accessibility constraint (e.g., constraints on tooling accessibility during machining) can be augmented to sensitivity field to ensure that the optimized (e.g., by topology optimization) part can be manufactured using machining. The framework, method, and system according to the present disclosure may enable automatic generation of structures such that the resulting shape is manufacturable using SM processes (as well as AM processes, which poses less constraints). Generating the consolidated designs takes into considerations of geometric, topological, material, and physical aspects of the available manufacturing capabilities and cannot be performed in isolation.

For example, in density-based topology optimization, a continuous density function is involved (e.g., ρ_{Ω}:Ω→[0, 1] to represent intermediate designs, rather than indicator functions). While a threshold 0<τ<1 (e.g., τ:=0.5) may be used to define the indicator functions as

1_{Ω}(x):=1iffρ_{Ω}(x)>τ,

the direct use of the density function may provide additional smoothing, according to the following:

$${f}_{IMF} ( x ; {ρ}_{O} , T , K ) := {min}_{R ∈ Θ} {min}_{k ∈ K} ( {ρ}_{O} * {ì}_{RT} ) ( x - R k ) .$$

The function ρ₀:Ω₀→[0, 1] can be obtained as: ρ₀(x):=ρ_{Ω}(x)+1_{F}(x), in which ρ_{Ω}(x) is obtained directly from topology optimization. The combined intrinsic mode function (IMF) for all tool assemblies f_{IMF}(x; ρ₀) is computed as below (where V_{Ssec} is the volume of secluded supports.).

$${f}_{IMF} ( x ; {ρ}_{O} ) := {min}_{1 \leq i \leq {n}_{T}} {f}_{IMF} ( x ; {ρ}_{O} , {T}_{i} , {K}_{i} )$$

$$\begin{matrix}{Minimize}_{Ω ⊆ {Ω}_{0}} & φ ( Ω ) , \\ such that & [ {K}_{Ω} ] [ {u}_{Ω} ] = [ f ] , \\ & {V}_{Ω} \leq {V}_{target} , \\ & {V}_{{S}_{sec}} = 0 ,\end{matrix}$$

In another example, to corporate the accessibility constraint for multi-axis machining, the sensitivity field Sc may be modified as follows:

S_{Ω}:=(1−w_{acc})S̅_{φ}+w_{acc}S̅_{IMF}

where 0≤w_{acc}<1 is the filtering weight for accessibility, and can be either a constant or adaptively updated based on the secluded volume V_{Γ(0)}. S̅_{φ}is the normalized sensitivity field with respect to the objective function.

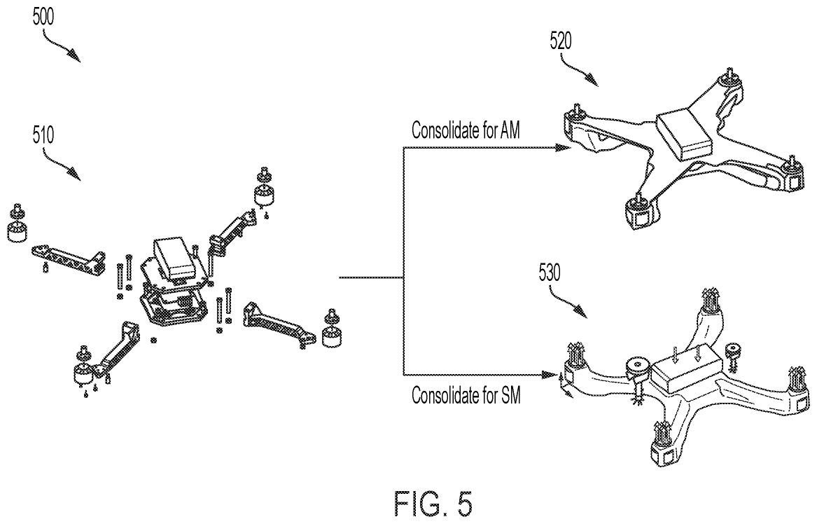

FIG. 5 illustrates an example 500 of consolidated designs 520 and 530, topologically optimized respectively for additive manufacturing or subtractive manufacturing, in accordance with certain aspects of the present disclosure. The multiple parts shown in the exploded view 510 may go through the consolidation process as discussed above in relation to FIGS. 1-4. As shown in FIG. 5, the consolidated designs 520 and 530 may be generated and tailored to different manufacturing constraints. For additive manufacturing (AM), topology optimization may result in hollow structures of the AM consolidated model 520 that may not be applicable to subtractive manufacturing (SM) techniques, such as computational numerical controlled (CNC) milling, as shown in the SM consolidated model 530 below (different milling heads are shown to illustrate multiple SM constraints may be applied). The consolidated designs 520 and 530 (either for AM or for SM on the right) may functionally replace the assembly of the multiple components 510 illustrated in the explosive view on the left.

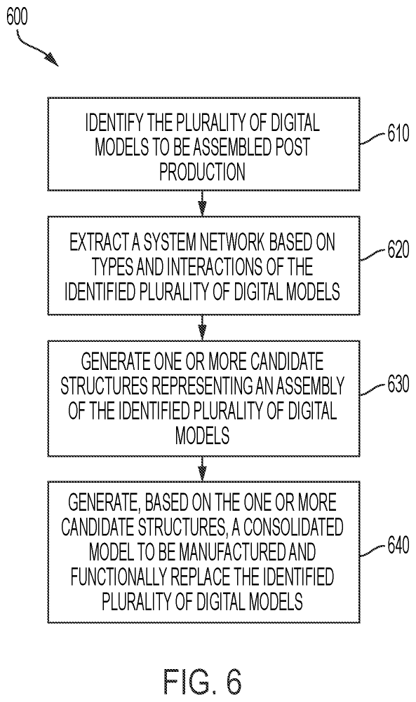

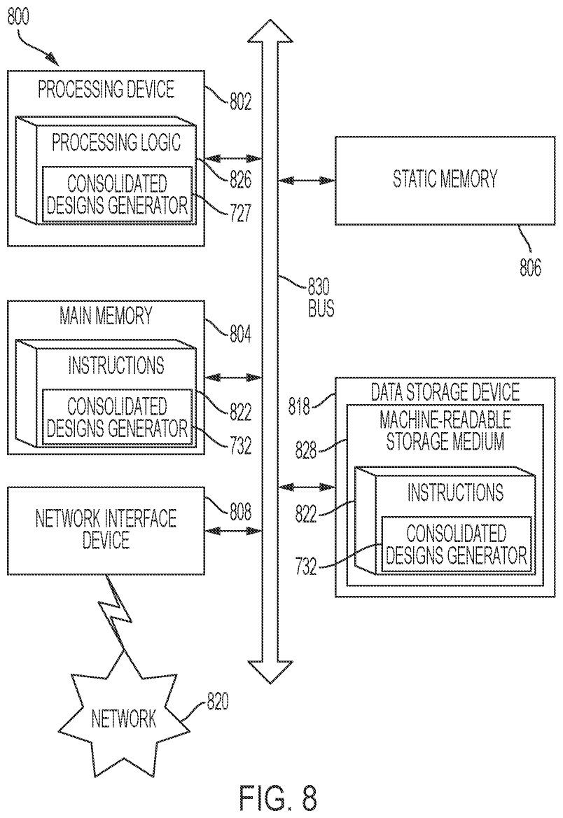

FIG. 6 illustrates a flow diagram of methods of operations 600, in accordance with certain aspects of the present disclosure. For example, the processes described with reference to FIG. 6 may be performed by a processing device, such as the processing device 802 as described with reference to FIG. 8. The operations 600 may be performed by an apparatus having a processing device and a memory coupled thereto. For example, the apparatus may include a manufacturing computational system managing production using AM and/or SM techniques.

The operations 600 begins at 610, by identifying the plurality of digital models to be assembled post production. For example, a user may specify a set of digital models to be consolidated or redesigned for production optimization or consolidation. Based on the assembly relationship of the set of digital models, the processing device may identify a subset of the digital models to be consolidated (e.g., including the digital models not meant to move relative to each other during operation, such as arms, fasteners, housing, etc.).

At 620, a system network is extracted (e.g., by upscaling) based on the types and interactions of the identified plurality of digital models. For example, as shown in Part III of FIG. 2A, the system network includes abstract nodes (e.g., not including dimensional information) that are generated to represent each component to be consolidated. The abstract nodes are connected by links representing the types and interactions, such as mechanical movements, electrical functions, or thermal transfers. In some cases, the system network may be represented using a design structure matrix, which allows for computing a graph energy to represent the complexity level of the system network.

At 630, one or more candidate structures are generated, the one or more candidate structures representing an assembly of the identified plurality of digital models. The one or more candidate structures may correspond to different combination or permutation of the plurality of digital models represented in the system network. For example, the candidate structures may represent different subsets of the digital models represented in the system network (e.g., by consolidating different selections of the abstract nodes, based on the relationship indicated in the design structure matrix).

At 640, based on the one or more candidate structures, a consolidated model is generated to be manufactured and functionally replace the identified plurality of digital models. For example, the consolidated model may be subject to the same physical constraints and functional conditions of the corresponding assembly of digital models. In some cases, topology optimization is used to refine and/or tailor the consolidated model to specific manufacturing techniques (e.g., AM, SM, or a combination thereof).

Various operations are described as multiple discrete operations, in turn, in a manner that is most helpful in understanding the present disclosure, however, the order of description may not be construed to imply that these operations are necessarily order dependent. In particular, these operations need not be performed in the order of presentation.

Operations performed by the processing device may be performed by the processing device with a memory coupled thereto.

In aspects, the processing device and the memory are further to: receive an initial set of digital models comprising computer aided design (CAD) models, wherein each of the initial set of digital models is to be individually manufactured and assembled with others in the initial set of digital models. In some cases, the plurality of digital models is identified from the initial set of digital models based on a set of production context corresponding to the types and interactions of the identified plurality of digital models. In some cases, at least part of the set of production context is based on input from a user.

In aspects, the processing device and the memory are to extract the system network by: abstracting each of the identified plurality of digital models into a volume-less symbol; and defining a relationship between every two of the identified plurality of digital models in a design structure matrix. In some cases, the relationship comprises at least one of: a relative motion or a lack thereof, stiffness, an electrical connection, a heat energy transfer, a boundary condition, or a loading condition. In some cases, the processing device and the memory are to generate the one or more candidate structures representing the assembly of the identified plurality of digital models by computing the one or more candidate structures based on a combination or a permutation of a subset of the volume-less symbols of the system network based on the defined relationship for different levels of complexity.

In some cases, the processing device and the memory are to generate the consolidated model to be manufactured by: performing topology optimization based on the one or more candidate structures and constraints of at least one of loading conditions, boundary conditions, manufacturing parameters, costs, or performance; and generating a set of parameters of the consolidated model for manufacturing based on results of the topology optimization. For example, the set of parameters of the consolidated model is used in additive manufacturing, subtractive manufacturing, or a combination of both.

In aspects, the set of production context may include a functional aspect of the identified plurality of digital models, including at least one of a key, a spacer, a housing, or a load bearing function performed by each of the plurality of digital models. The set of production context may also include a connection aspect of the identified plurality of digital models, including at least a relative movement or fixation between two or more of the plurality of digital models. The connection aspect may represent an assembly relationship of the two or more of the plurality of digital models. In some cases, the set of production context may include production techniques used to produce the identified plurality of digital models and the corresponding properties.

In some cases, the set of production context may include production techniques used to produce the consolidated model. For example, when AM is used, the production context may include material deposition properties, material settings, work environment settings, power settings, among others. When SM is used, the production context may include accessibility of machining, machining precisions, mechanics of tools and materials, etc. The topology optimization may consider various aspects of the production context for optimizing the geometry of the consolidated model.

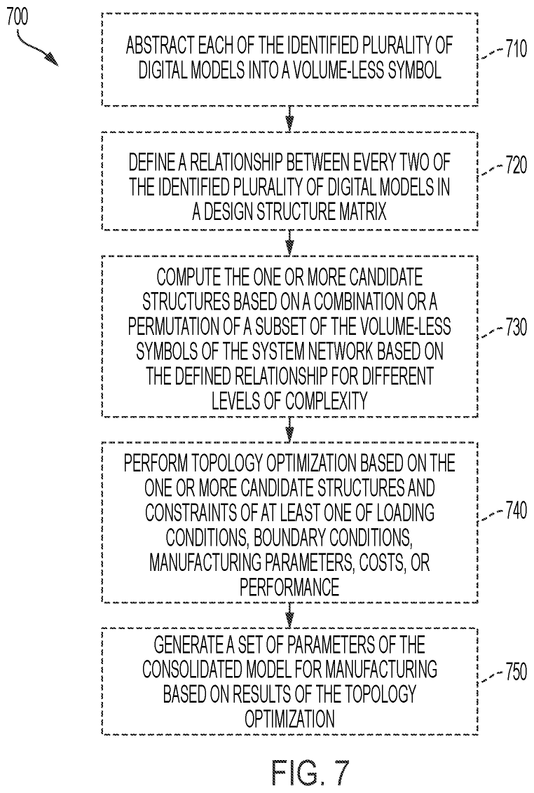

FIG. 7 illustrates a flow diagram of methods of operations 700, in accordance with certain aspects of the present disclosure. The operations 700 may supplement the operations 600 in some particular aspects. One or more of the operations 700 may be optional for the operations 600.

The operations 700 begins at 710, by abstracting each of a number of identified digital models into a volume-less symbol. For example, the volume-less symbol may include a graph energy value, or its design structure matrix of a system network representing a legacy assembly of components, as the structural matrix 240 illustrated in FIGS. 2B-2C.

At 720, a relationship between every two of the identified digital models is defined in the design structure matrix. An example is shown in Part IV of FIGS. 2B-2C, which show connection relationships between two connected nodes are numerically represented in the design structure matrix 240.

At 730, one or more candidate structures are computed based on a combination or a permutation of a subset of the volume-less symbols of the system network based on the defined relationship for different levels of complexity. An example of multiple candidate structures 410-440 are illustrated in FIG. 4. The various complexity levels allow for evaluation of tradeoffs between system complexity and other aspects (e.g., strength, weight savings, failure modes, etc.) of the system network.

At 740, topology optimization may be performed based on the one or more candidate structures and constraints of at least one of the loading conditions, boundary conditions, manufacturing parameters, costs, or performance of the consolidated model.

At 750, a set of parameters for manufacturing the consolidated model is generated based on results of the topology optimization at 740. For example, the set of parameters may correspond to the manufacturing presumptions used in the topology optimization and may further include production parameters to be applied in particular manufacturing devices (e.g., the AM manufacturing system 300 of FIG. 3A and/or the SM manufacturing system 311 of FIG. 3B).

FIG. 8 illustrates a diagrammatic representation of a machine in the example form of a computer system 800 within which a set of instructions 822, for causing the machine to perform any one or more of the methodologies discussed herein (such as the operations 800), may be executed. In various embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 800 may be representative of a server computer system.

The exemplary computer system 800 includes a processing device 802, a main memory 804 (e.g., read-only memory (ROM), flash memory, dynamic random access memory (DRAM), a static memory 806 (e.g., flash memory, static random access memory (SRAM), etc.), and a data storage device 818, which communicate with each other via a bus 830. The processing device 802 may be implemented as the topology optimization processing device 160 or a related processing device unit, a system processing device (e.g., including the computational layer 150), or both. In some cases, the processing device 802 may be used to perform tasks associated with the surrogate model 130. Any of the signals provided over various buses described herein may be time multiplexed with other signals and provided over one or more common buses. Additionally, the inter 828 connection between circuit components or blocks may be shown as buses or as single signal lines. Each of the buses may alternatively be one or more single signal lines and each of the single signal lines may alternatively be buses.

Processing device 802 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 may execute processing logic 826, for performing the operations and steps discussed herein. The processing logic 826 may include a consolidated designs generator 828 for performing the operations 600 of FIG. 6.

The data storage device 818 may include a machine-readable storage medium 828, on which is stored one or more set of instructions 822 (e.g., software) embodying any one or more of the methodologies of functions described herein, including instructions to cause the processing device 802 to execute system 100. The instructions 822 may also reside, completely or at least partially, within the main memory 804 or within the processing device 802 during execution thereof by the computer system 800; the main memory 804 and the processing device 802 also constituting machine-readable storage media. The instructions 822 may further be transmitted or received over a network 820 via the network interface device 808. The instructions 822 may include instructions for the consolidated designs generator 832 for performing the operations 600 of FIG. 6.

The non-transitory machine-readable storage medium 728 may also be used to store instructions to perform the methods and operations described herein. While the machine-readable storage medium 728 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof.

What is claimed is:

1. An apparatus for consolidating a plurality of digital models to be manufactured, the apparatus comprising:
a memory;
a processing device operably coupled to the memory, the processing device and the memory to:
identify the plurality of digital models to be assembled post production;
extract a system network based on types and interactions of the identified plurality of digital models;
generate, based on the system network, one or more candidate structures representing an assembly of the identified plurality of digital models; and
generate, based on the one or more candidate structures, a consolidated model to be manufactured and functionally replace the identified plurality of digital models.

2. The apparatus of claim 1, wherein the processing device and the memory are further to:
receive an initial set of digital models comprising computer aided design (CAD) models, wherein each of the initial set of digital models is to be individually manufactured and assembled with others in the initial set of digital models.

3. The apparatus of claim 2, wherein the plurality of digital models is identified from the initial set of digital models based on a set of production context corresponding to the types and interactions of the identified plurality of digital models.

4. The apparatus of claim 3, wherein the set of production context comprises:
a functional aspect of the identified plurality of digital models, including at least one of a key, a spacer, a housing, or a load bearing function performed by each of the plurality of digital models; and
a connection aspect of the identified plurality of digital models, including at least a relative movement or fixation between two or more of the plurality of digital models, wherein the connection aspect represents an assembly relationship of the two or more of the plurality of digital models.

5. The apparatus of claim 1, wherein the processing device and the memory are to extract the system network by:
abstracting each of the identified plurality of digital models into a volume-less symbol; and
defining a relationship between every two of the identified plurality of digital models in a design structure matrix.

6. The apparatus of claim 5, wherein the relationship comprises at least one of: a relative motion or a lack thereof, stiffness, an electrical connection, a heat energy transfer, a boundary condition, or a loading condition.

7. The apparatus of claim 6, wherein the processing device and the memory are to generate the one or more candidate structures representing the assembly of the identified plurality of digital models by:
computing the one or more candidate structures based on a combination or a permutation of a subset of the volume-less symbols of the system network based on the defined relationship for different levels of complexity.

8. The apparatus of claim 7, wherein the processing device and the memory are to generate the consolidated model to be manufactured by:
performing topology optimization based on the one or more candidate structures and constraints of at least one of loading conditions, boundary conditions, manufacturing parameters, costs, or performance; and
generating a set of parameters of the consolidated model for manufacturing based on results of the topology optimization.

9. The apparatus of claim 8, wherein the set of parameters of the consolidated model is used in additive manufacturing, subtractive manufacturing, or a combination of both.

10. A method for consolidating a plurality of digital models to be manufactured, the method comprising:
identifying the plurality of digital models to be assembled post production;
extracting a system network based on types and interactions of the identified plurality of digital models;
generating, by a processing device based on the system network, one or more candidate structures representing an assembly of the identified plurality of digital models; and
generating, based on the one or more candidate structures, a consolidated model to be manufactured and functionally replace the identified plurality of digital models.

11. The method of claim 10, further comprising:
receiving an initial set of digital models comprising computer aided design (CAD) models, wherein each of the initial set of digital models is to be individually manufactured and assembled with others in the initial set of digital models.

12. The method of claim 11, further comprising:
identifying the plurality of digital models from the initial set of digital models based on a set of production context corresponding to the types and interactions of the identified plurality of digital models.

13. The method of claim 12, wherein the set of production context comprises:
a functional aspect of the identified plurality of digital models, including at least one of a key, a spacer, a housing, or a load bearing function performed by each of the plurality of digital models; and
a connection aspect of the identified plurality of digital models, including at least a relative movement or fixation between two or more of the plurality of digital models, wherein the connection aspect represents an assembly relationship of the two or more of the plurality of digital models.

14. The method of claim 13, wherein extracting the system network based on the types and interactions of the identified plurality of digital models comprises:
abstracting each of the identified plurality of digital models into a volume-less symbol; and
defining a relationship between every two of the identified plurality of digital models in a design structure matrix.

15. The method of claim 14, wherein the relationship comprises at least one of: a relative motion or a lack thereof, stiffness, an electrical connection, a heat energy transfer, a boundary condition, or a loading condition.

16. The method of claim 15, wherein generating the one or more candidate structures representing the assembly of the identified plurality of digital models comprises:
computing the one or more candidate structures based on a combination or a permutation of a subset of the volume-less symbols of the system network based on the defined relationship for different levels of complexity.

17. The method of claim 16, wherein generating the consolidated model to be manufactured comprises:
performing topology optimization based on the one or more candidate structures and constraints of at least one of loading conditions, boundary conditions, manufacturing parameters, costs, or performance; and
generating a set of parameters of the consolidated model for manufacturing based on results of the topology optimization.

18. The method of claim 17, wherein the set of parameters of the consolidated model is used in additive manufacturing, subtractive manufacturing, or a combination of both.

19. A non-transitory computer-readable storage medium having instructions stored thereon that, when executed by a processing device for consolidating a plurality of digital models to be manufactured, cause the processing device to:
identify the plurality of digital models to be assembled post production;
extract a system network based on types and interactions of the identified plurality of digital models;
generate, based on the system network, one or more candidate structures representing an assembly of the identified plurality of digital models; and
generate, based on the one or more candidate structures, a consolidated model to be manufactured and functionally replace the identified plurality of digital models.

20. The non-transitory computer-readable storage medium of claim 19, further comprising instructions that cause the processing device to generate the consolidated model to be manufactured by:
performing topology optimization based on the one or more candidate structures and constraints of at least one of loading conditions, boundary conditions, manufacturing parameters, costs, or performance; and
generating a set of parameters of the consolidated model for manufacturing based on results of the topology optimization.
